(19) United States
(12) Patent Application Publication
(10) Pub. No.: US 2020/0179942 A1
(43) Pub. Date: Jun. 11, 2020

(54) MAGNETIC SEPARATOR

(71) Applicant: KE HUANG CORP., Zhubei City (TW)

(72) Inventors: Wen-Cheng CHANG, Zhubei City (TW); Ken-Der LIN, Zhubei City (TW); Jie LIN, Zhubei City (TW); Bao-Ding LI, Zhubei City (TW)

(73) Assignee: KE HUANG CORP., Zhubei City (TW)

(21) Appl. No.: 16/406,988

(22) Filed: May 8, 2019

(30) Foreign Application Priority Data
Dec. 5, 2018 (TW) 107143739

(51) Int. Cl. B03C 1/033; H01F 7/02; H01F 1/057

(52) U.S. Cl. CPC B03C 1/0332; B03C 2201/20; H01F 1/057; H01F 7/02

(57) ABSTRACT

A magnetic separator includes two parallel and spaced magnetic rods. Each magnetic rod includes a non-magnetic tubular body with a longitudinal axis and a chamber, a plurality of magnetic members nested in the chamber, and a plurality of spacers made of high magnetic permeability materials and respectively disposed between the adjacent magnetic members. The magnetic members in each magnetic rod are disposed with like poles adjacent each other. Poles of the magnetic members in one magnetic rod are opposite to poles of the nearest adjacent magnetic members in another magnetic rod. The width of each magnetic member in the longitudinal axis of the tubular body is larger than that of each spacer so that a matrix type magnetic flux lines can be formed by the grate magnetic separator.

### BACKGROUND OF THE INVENTION

### 1. Field of the Invention

The present invention relates to magnetic separators with permanent magnets, and in particular to a magnetic separator provided with matrix type magnetic flux lines to effectively remove unwanted ferrous metals during the processing of raw materials.

### 2. Description of the Related Art

It was known that there has a wide variety of magnetic separators for being used in many processing industries to remove ferrous and para-magnetic contamination from products and production lines, particularly in grain, food and chemical industries. Such contamination may arise in the form of metal fragments, staples and nails from packaging, nuts and bolts from processing machinery, wear and tear from moving frictional parts, magnetic stone and/or rust which could potentially cause production machinery damage or product contamination.

With regard to grate type magnetic separators, one of known prior arts is disclosed by U.S. Pat. No. 2,733,812. The grate magnet has spaced tubes made of non-magnetic material and permanent magnets disposed in the tubes. The magnets are disposed with like poles adjacent each other in each the tube, and the poles of each magnet are unlike the nearest adjacent poles of magnets adjacent the tubes. The disadvantage of such a design is that the magnetic flux lines are not uniformly distributed so that unwanted ferrous metals that can be captured are extremely limited, and in particular, it is impossible to catch fine ferromagnetic impurities. That is to say, a more effective magnetic separator has yet to be proposed.

### SUMMARY OF THE INVENTION

Thus, one aspect of the present invention includes an improving grate magnetic separator comprising at least two parallel and spaced magnetic rods. Each of the magnetic rods includes a tubular body made of non-magnetic materials with a longitudinal axis and a chamber. A plurality of magnetic members are nested in the chamber along the longitudinal axis. A plurality of spacers made of a material having a high magnetic permeability or a high saturation magnetization are respectively disposed between the two adjacent magnetic members. The magnetic members in each of the magnetic rods are disposed with like poles adjacent each other. Poles of the magnetic members in one magnetic rod are opposite to poles of the nearest adjacent magnetic members in another magnetic rod. Each of the magnetic members has a first width in the longitudinal axis of the tubular body, each of the spacers has a second width in the longitudinal axis of the tubular body, and the first width is larger than the second width. For having the structure mentioned above, the grate magnetic separator can form a matrix type magnetic flux lines to effectively remove unwanted ferrous metals during the processing of raw materials.

In another aspect of the present invention, the grate magnetic separator further comprises a frame to secure the magnetic rods spaced from each other at a suitable distance and in a common plane.

In yet another aspect of the present invention, the first width of each of the magnetic members is of about 10 to 25 times the second width of each of the spacers such that a higher intensity of magnetic field can be formed by the grate magnetic separator. Preferably, the first width of each of the magnetic members is of about 12 to 15 times the second width of each of the spacers

In one embodiment of the present invention, the magnetic members are made of rare earth magnets, such as NdFeB magnets and the spacers are made of pure iron, low carbon steel or iron-cobalt alloy.

In another embodiment of the present invention, the tubular body is made of stainless steel, titanium alloy, copper alloy or aluminum alloy.

There has thus been outlined, rather broadly, certain embodiments of the disclosure in order that the detailed description thereof herein may be better understood, and in order that the present contribution to the art may be better appreciated. There are, of course, additional embodiments that will be described below and which will form the subject matter of the claims appended hereto.

In this respect, before explaining at least one embodiment in detail, it is to be understood that the disclosure is not limited in its application to the details of construction and to the arrangements of the components set forth in the following description or illustrated in the drawings. The disclosed device is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the various embodiments. It is important, therefore, that the claims be regarded as including such equivalent constructions insofar as they do not depart from the spirit and scope of the various embodiments.

### BRIEF DESCRIPTION OF THE DRAWINGS

FIG. 1 is a perspective view of a grate magnetic separator according to the present invention;

FIG. 2 is a perspective view of a magnetic rod of the grate magnetic separator according to the present invention;

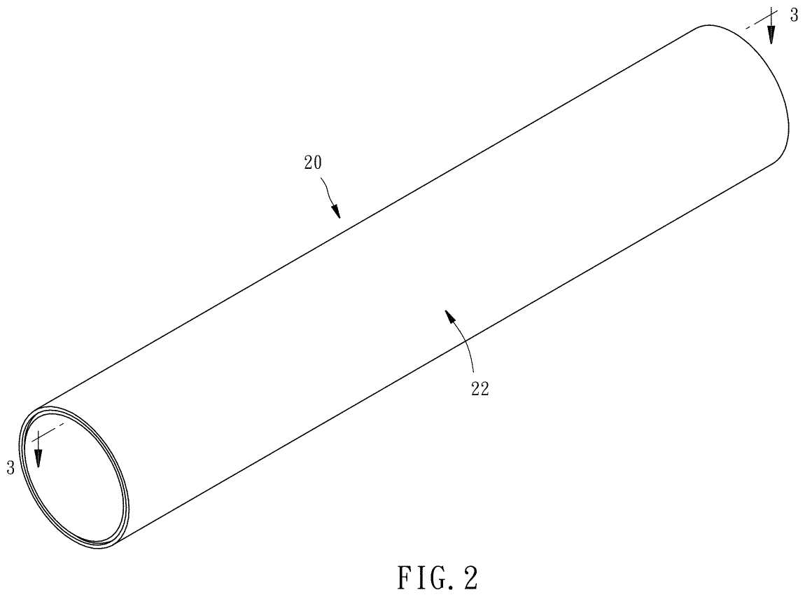

FIG. 3 is a sectional view taken along line 3-3 of FIG. 2;

FIG. 4 is a sectional view of two adjacent magnetic rods of the grate magnetic separator according to the present invention, showing in detail the distribution of the magnetic flux lines formed by the two adjacent magnetic rods; and

FIG. 5 is an image of the magnetic flux lines formed by the grate magnetic separator according to the present invention.

### DETAILED DESCRIPTION OF SPECIFIC EMBODIMENTS

It will be readily understood that the components of the present invention, as generally described and illustrated in the Figures herein, could be arranged and designed in a wide variety of different configurations. Thus, the following more detailed description of the exemplary embodiment of the present invention, as represented in the Figures, is not intended to limit the scope of the invention, as claimed, but is merely representative of the embodiment of the invention.

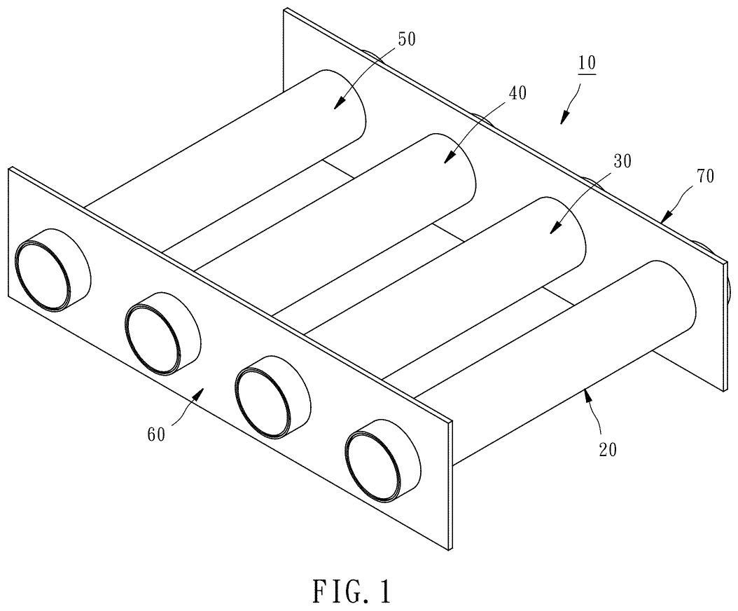

Referring now to the drawings, a grate magnetic separator embodying one aspect of the present invention generally indicated at 10 in FIG. 1, includes a frame including a pair of opposed spaced side plates 60, 70, four magnetic rods 20, 30, 40, and 50 are spacedly secured within the side plates 60,70 in a way that the four magnetic rods 20, 30, 40, and 50 are parallel to each other and in a common plane. In this embodiment, the magnetic rods 20 and 40 are identical in material, size, and internal structure, and the magnetic rods 30 and 50 are identical in material, size, and internal structure. Therefore, the following will only give a detailed description of the first magnetic rod 20 and the second magnetic rod 30.

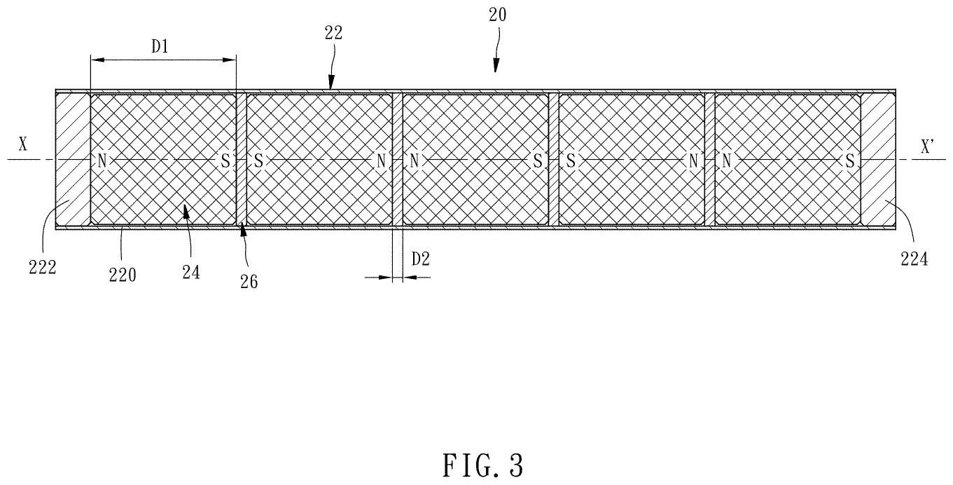

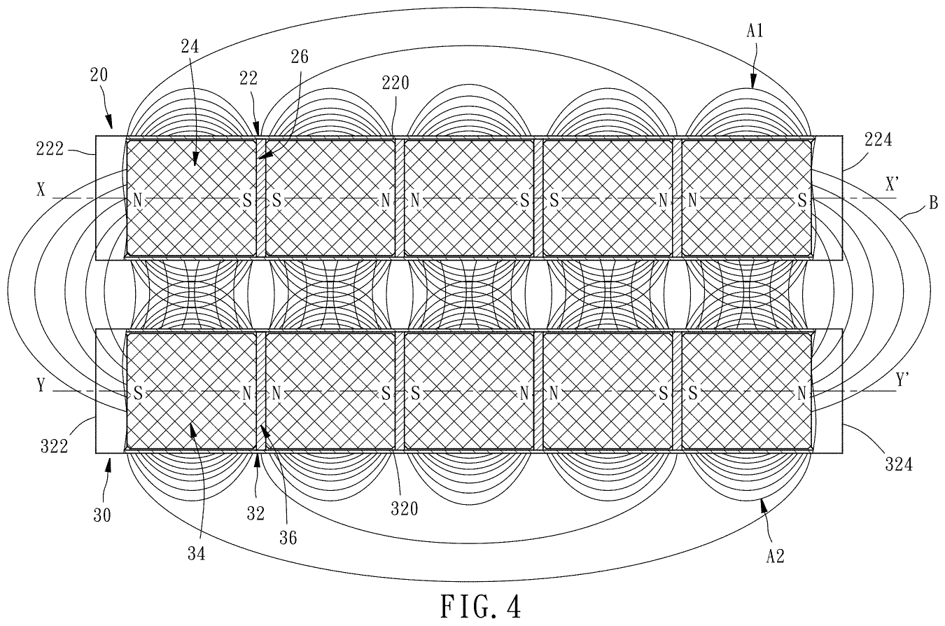

The first magnetic rod 20, as shown in FIGS. 3-4, includes a first tubular body 22 made of non-magnetic material such as stainless steel, titanium alloy, copper alloy or aluminum alloy, five first magnetic members 24 made of NdFeB magnets, and four first spacers 26 made of high magnetic permeability or high saturation magnetization materials such as pure iron, low carbon steel or iron-cobalt alloy. The first tubular body 22 has a chamber 220 with two closed ends 222, 224 and a longitudinal axis X-X′. Each first magnetic member 24 is disposed with like poles adjacent each other, such as North-South, South-North, North-South, South-North North-South, in the chamber 220 along the longitudinal axis X-X′. Each first spacer 26 is disposed between the two adjacent first magnetic members 24.

In general, the first tubular body 22 has a length of about 60 mm to 2500 mm, an outer diameter of about 25 mm to 100 mm, and an inner diameter of about 24 mm to 100 mm. The numbers and dimensions of the first magnetic members 24 and the first spacers 26 are designed to match the dimensions of the tubular body 22.

In this embodiment, the chamber 220 of the first tubular body 22 has a length of about 212 mm, an outer diameter of about 25 mm, and an inner diameter of about 24 mm. Each first magnetic member 24 has a first width D1 in the longitudinal axis X-X′ of about 40 mm and an outer diameter of slightly less than 24 mm. Each first spacer 26 has a second width D2 in the longitudinal axis X-X′ of about 3 mm, and an outer diameter of slightly less than 24 mm. The first width D1 of each first magnetic member 24 is of about 13 times the second width D2 of each first spacer 26.

The second magnetic rod 30, as shown in FIG. 4, includes a second tubular body 32 made of non-magnetic material such as stainless steel, titanium alloy, copper alloy or aluminum alloy, five second magnetic members 34 made of NdFeB magnets, and four second spacers 36 made of high magnetic permeability or high saturation magnetization materials such as pure iron, low carbon steel or iron-cobalt alloy. The second tubular body 32 has a chamber 320 with two closed ends 322, 324 and a longitudinal axis Y-Y′. The second magnetic members 34 are disposed in the chamber 320 along the longitudinal axis Y-Y′ in such a way that the like poles of the adjacent magnetic members 34 are opposed to each other and the poles of the second magnetic members 34 are opposite to the poles of the nearest adjacent first magnetic members 24, such as South-North, North-South, South-North, North-South, South-North. Each second spacer 36 is disposed between the two adjacent second magnetic members 34. In this embodiment, the second tubular body 32 has the same size as the first tubular body 22. In other words, the second tubular body 32 has a length of about 212 mm, an outer diameter of about 25 mm, and an inner diameter of about 24 mm. Each second magnetic member 34 has a third width in the longitudinal axis Y-Y′ of about 40 mm and an outer diameter of slightly less than 24 mm. Each second spacer 36 has a fourth width in the longitudinal axis Y-Y′ of about 3 mm, and an outer diameter of slightly less than 24 mm. The third width of each second magnetic member 34 is of about 13 times the fourth width of each second spacer 36.

The structure and size of the magnetic rod 40 are the same as those of the magnetic rod 20. And the structure and size of the magnetic rod 50 are the same as those of the magnetic rod 30. Thus, it will not be detailedly described here.

As shown in FIG. 4, the magnetic flux lines produced by each first magnetic member 24 of the first magnetic rod 20 is indicated at A1, the magnetic flux lines produced by each second magnetic member 34 of the second magnetic rod 30 is indicated at A2, and the magnetic flux lines produced by the poles of each first magnetic members 24 and each nearest adjacent second magnetic members 34 is indicated at B so that a matrix type magnetic flux lines can be formed by the grate magnetic separator 10.

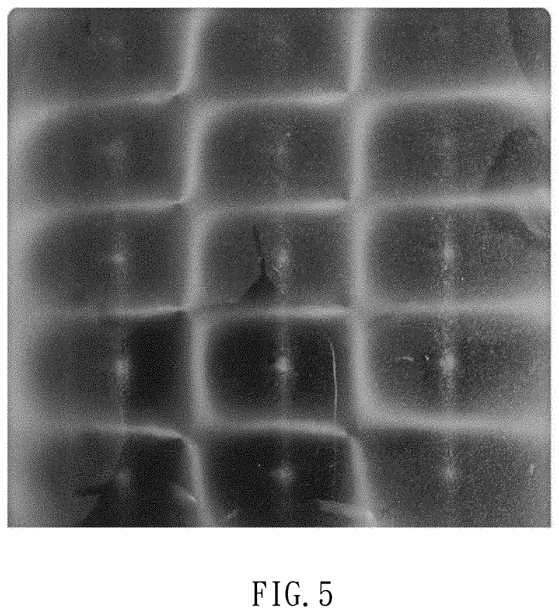

When a magnetic field detection card is put over the grate magnetic separator 10, as shown in FIG. 5, the image of the matrix type magnetic flux lines will be clearly displayed in green fluorescent light. In other words, the magnetic flux lines produced by the grate magnetic separator 10 are like a lot of fine meshes, and can effectively captured unwanted ferrous metals during the processing of raw materials. Particularly, the maximum magnetic flux density of the grate magnetic separator 10 is approximately greater than or equal to 13,700 Gs.

What is claimed is:

1. A grate magnetic separator comprising:
at least two parallel and spaced magnetic rods, each of the magnetic rods including a tubular body made of non-magnetic materials with a longitudinal axis and a chamber;
a plurality of magnetic members being nested in the chamber along the longitudinal axis;
a plurality of spacers made of a material having a high magnetic permeability or a high saturation magnetization being respectively disposed between the two adjacent magnetic members;
the magnetic members in each of the magnetic rods being disposed with like poles adjacent each other, and poles of the magnetic members in one magnetic rod being opposite to poles of the nearest adjacent magnetic members in another magnetic rod; and
each of the magnetic members having a first width in the longitudinal axis of the tubular body, each of the spacers having a second width in the longitudinal axis of the tubular body, and the first width being larger than the second width.

2. The magnetic separator of claim 1, further comprising a frame having a pair of opposed spaced side plates to spacedly secure the magnetic rods in a way that each of the magnetic rods is parallel to each other and in a common plane.

3. The magnetic separator of claim 1, wherein the first width is 10 to 25 times the second width.

4. The magnetic separator of claim 3, wherein the first width is 12 to 15 times the second width.

5. The magnetic separator of claim 4, wherein the first width is about 25 mm, and the second width is about 1.2 mm.

6. The magnetic separator of claim 1, wherein the tubular body is made of stainless steel, titanium alloy, copper alloy or aluminum alloy.

7. The magnetic separator of claim 1, wherein the magnetic members are made of rare earth magnets.

8. The magnetic separator of claim 7, wherein the magnetic members are made of NdFeB magnets.

9. The magnetic separator of claim 1, wherein the spacers are made of pure iron, low carbon steel or iron-cobalt alloy.
